(19) United States
(12) Patent Application Publication
(10) Pub. No.: US 2025/0037175 A1
(43) Pub. Date: Jan. 30, 2025

(54) DATA PROCESSING SYSTEM INCLUDING FIRST COMPUTER TRANSFERRING DATA FROM READING DEVICE TO SECOND COMPUTER

(71) Applicant: BROTHER KOGYO KABUSHIKI KAISHA, Nagoya (JP)

(72) Inventor: Tetsuya OKUNO, Nagoya (JP)

(21) Appl. No.: 18/765,495

(22) Filed: Jul. 8, 2024

(30) Foreign Application Priority Data
Jul. 25, 2023 (JP) 2023-120734

(51) Int. Cl. G06Q 30/04; G06K 15/02; H04N 1/00

(52) U.S. Cl. CPC G06Q 30/04; G06K 15/1848; H04N 1/00244; H04N 1/00708; H04N 1/00795; H04N 2201/0081

(57) ABSTRACT

The data processing system includes a reading device and a first computer. The first computer communicates with the reading device and a second computer. The reading device performs a reading process to read an original document to generate a set of resultant data based on the read original document, and a transmission process to transmit the set of resultant data to the first computer. The first computer performs a transferring process to transfer the set of resultant data received from the reading device to the second computer, and an acquisition process to acquire a billing amount or an evaluation value. The billing amount and the evaluation value both are based on information concerning the set of resultant data. The billing amount is an amount of a fee to be charged, the evaluation value being a value for use in calculating the billing amount.

### REFERENCE TO RELATED APPLICATIONS

This application claims priority from Japanese Patent Application No. 2023-120734 filed on Jul. 25, 2023. The entire content of the priority application is incorporated herein by reference.

### BACKGROUND ART

Conventionally, a scanner or other reading device reads an original document, and the reading results are then transmitted to a server or other computer along a suitable communication path. As an example, a student creates a paper to be submitted, scans the paper with a scanner, and uploads the reading results to an education management system through a personal computer.

### SUMMARY

Here, it is conceivable that a paid service can be introduced as a method of transmitting the reading results for original documents to the computer. In such a conceivable service, reading results are transferred from the reading device to the target computer through another computer, and the user of the paid service incurs a predetermined charge for these transfers. However, the fee for the use of the service should be reasonable for both the user and provider of the service.

In view of the foregoing, it is an object of the present disclosure to provide an information processing system that charges reasonable fees for the use of services.

In view of the foregoing, it is an object of the present disclosure to provide an image forming apparatus a data processing system. The data processing system includes a reading device and a first computer. The first computer is configured to communicate with the reading device and a second computer. The reading device is configured to perform: a reading process to read an original document to generate a set of resultant data based on the read original document; and a transmission process to transmit the set of resultant data to the first computer. The first computer is configured to perform: a transferring process to transfer the set of resultant data received from the reading device to the second computer; and an acquisition process to acquire a billing amount or an evaluation value, the billing amount and the evaluation value both being based on information concerning the set of resultant data, the billing amount being an amount of a fee to be charged, the evaluation value being a value for use in calculating the billing amount.

In the above structure, because the billing amount or the evaluation value is based on the set of resultant data, the billing amount can be set reasonably.

In order to attain the above and other objects, the present disclosure provides a data processing system. The data processing system includes a reading device, and a first computer. The first computer is configured to communicate with the reading device and a second computer. The reading device is configured to perform: a reading process to read an original document to generate a set of resultant data based on the read original document; and a transmission process to transmit the set of resultant data to the first computer. The first computer is configured to perform: providing a flat-fee service while a prescribed condition is satisfied, the flat-fee service being a service to transfer each set of resultant data received from the reading device to the second computer for a prescribed time period at a flat fee, the prescribed condition including a condition that a transferred-data size of one or more sets of resultant data that have been transferred from the first computer to the second computer for the prescribed time period is less than an upper limit; and after the prescribed condition is not satisfied, at least one of: a first process to transfer the set of resultant data received from the reading device to the second computer at a transfer speed lower than a transfer speed when the prescribed condition is satisfied; a second process to transfer the set of resultant data to the second computer while charging an additional fee; or a third process to skip transferring of the set of resultant data from the first computer to the second computer.

In the above structure, while the prescribed condition is satisfied, the flat fee is charged whereas after prescribed condition is not satisfied, the transfer speed is reduced, the additional fee is charged, or skipping transferring the set of resultant data. Accordingly, the fee can be set reasonably.

### BRIEF DESCRIPTION OF DRAWINGS

FIG. 1 is a block diagram illustrating a homework submission system.

FIG. 2 is a sequence diagram illustrating a series of processes performed by the homework submission system shown in FIG. 1.

FIG. 3 is a block diagram illustrating a homework submission system.

FIG. 4 is a block diagram illustrating a homework submission system.

FIG. 5 is a sequence diagram illustrating a series of processes performed by the homework submission system shown in FIG. 4.

FIG. 6 is a block diagram illustrating a homework submission system.

### DESCRIPTION

### First Embodiment

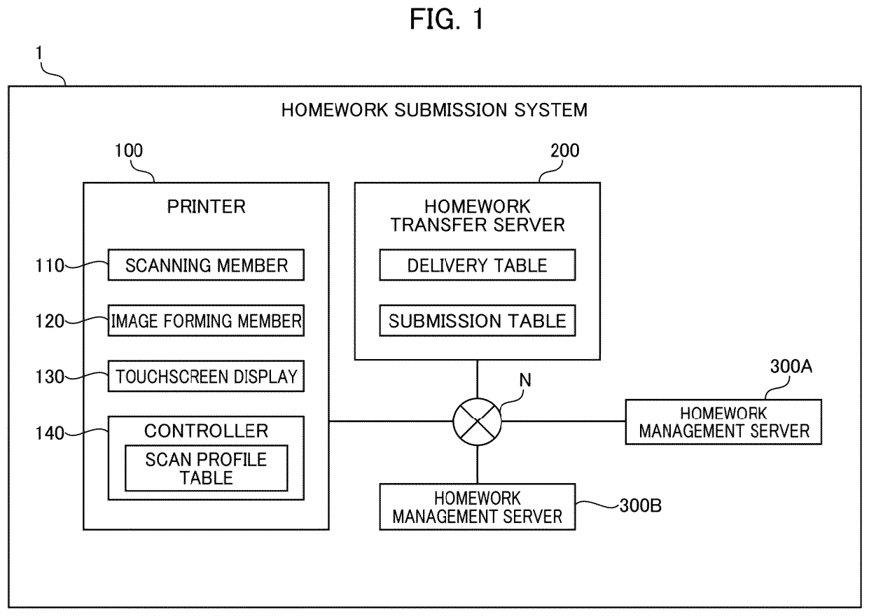

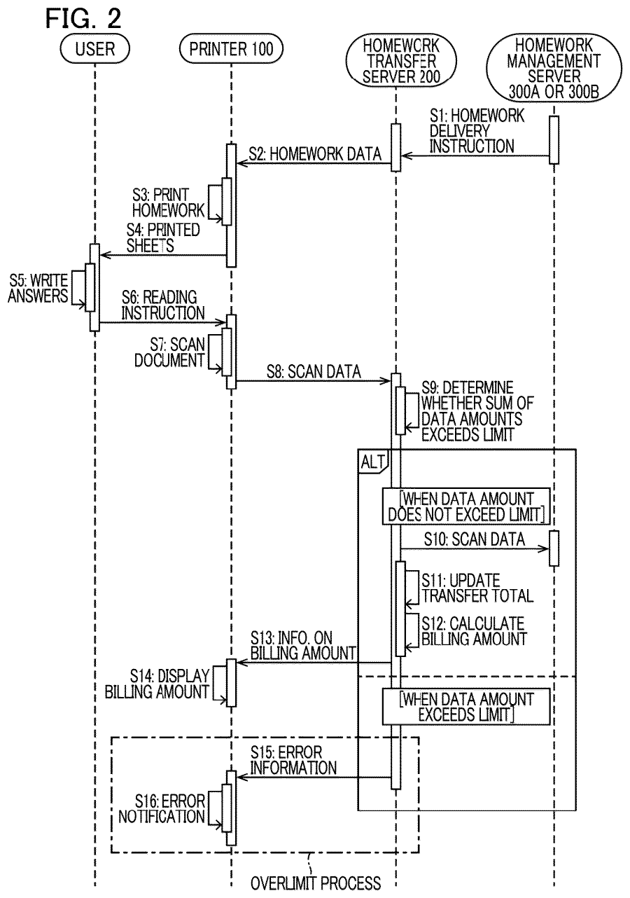

A homework submission system 1 according to a first embodiment will be described below with reference to FIGS. 1 and 2. The homework submission system 1 (an example of the “information processing system”) is a system that supports submissions of homework assignments for an educational service that education providers or the like provide to end users. This embodiment will assume a case in which a given end user has entered contracts with both education provider A and education provider B.

As shown in FIG. 1, the homework submission system 1 has a printer 100, a homework transfer server 200, and homework management servers 300A and 300B. The printer 100, the homework transfer server 200, and the homework management servers 300A and 300B can communicate with each other over a communication network N, such as the Internet. The homework transfer server 200 is operated by provider X. Provider X provides a data transfer service. The homework management server 300A is operated by education provider A, and the second server 300B is operated by education provider B.

The printer 100 (an example of the “reading device”) has a scanning member 110, an image forming member 120, a touchscreen display 130, and a controller 140.

The scanning member 110 (an example of the “scanning device”, “reading assembly”, “scanner”, “reading engine” or “reader”) has a reading surface on which an original document is placed. The scanning member 110 may include light sources emitting light toward a sheet and an optical sensor to receive light reflected off the sheet so as to generate scan data based on the received light. The document is a sheet of printing paper or other sheet-like medium formed of paper, cloth, or the like on which an image is formed and characters, figures, and the like are handwritten, for example. As described below, the reading target in the present embodiment is a document, and specifically printing paper on which the image forming member 120 has printed a homework assignment. The scanning member 110 reads the characters, figures, images, and the like formed on the surface of the document placed on the reading surface of the scanning member 110 and generates reading image data (scan data) representing the read image.

When scanning a document with the scanning member 110, the operator can select a color mode and a resolution mode. The operator can select monochrome or color as the color mode and can select high resolution or low resolution as the resolution mode. The high resolution and low resolution may be set to any resolution values, provided that the high-resolution value is greater than the low-resolution value. As an example, the high resolution may be 600 dots per inch (dpi) while the low resolution is 100 dpi.

The image forming member 120 (an example of the “image forming device”, “printing device”, “printing assembly”, “printing engine”, or “printer”) forms an image represented by image data on printing paper accommodated therein by depositing ink on this printing paper. The image forming member 120 may include a print head including nozzles to eject ink toward the printing paper. The image data used for this image formation is transmitted to the printer 100 from the homework transfer server 200 or another external device.

The touchscreen display 130 can receive user input. That is, when a user touches the screen of the touchscreen display 130 with a finger or the like, the touchscreen display 130 detects the contact position and outputs detection results to the controller 140, thereby enabling various types of user input through the touchscreen display 130. For example, an end user of the printer 100 can input various instructions, through the touchscreen display 130, including an instruction to begin reading with the scanning member 110 and an instruction to begin image formation with the image forming member 120.

The controller 140 executes various processes through the cooperation of hardware such as a central processing unit (CPU), memory including read-only memory (ROM) and random-access memory (RAM), an application-specific integrated circuit (ASIC), and electronic circuits that perform data communication processes with external devices; and software stored in the memory or other storage device. Through these processes, the controller 140 controls operations of the printer 100 in accordance with instructions received from external devices.

Operations performed by the printer 100 under control of the controller 140 include a homework printing operation and an answer reading operation described below.

In the homework printing operation, the printer 100 prints homework on one or more printing papers based on homework data received from the homework transfer server 200. The homework data is image data for images depicting the content of the homework. The controller 140 controls the image forming member 120 to form the images on one or more printing papers based on the homework data received from the homework transfer server 200, thereby printing homework depicted by the homework data on printing paper.

In the answer reading operation, the controller 140 controls the scanning member 110 to read answers (answers to questions in the homework) written on a document that is the printing paper(s) on which the homework was printed in the homework printing operation. To perform this operation, the end user places the document with the answers (or, answer sheet(s)) to be read on the reading surface of the scanning member 110 and inputs a user instruction through the touchscreen display 130 to begin reading the document. The printer 100 may also possess a conveying mechanism to convey a plurality of sheets of a document over the reading surface one sheet at a time.

In this embodiment, the end user selects a scan profile as part of the user input for reading a document. The scan profile can be selected from a scan profile table. Table 1 below shows an example of a scan profile table. The scan profile table includes a plurality of scan profiles. Each scan profile is saved in the controller 140 and includes a user ID, a transfer ID, and a scanning mode. The scanning mode indicates the color mode and resolution mode described above. As will be described later, the transfer ID indicates an association between the end user and a destination server. The example in Table 1 includes scan profiles Nos. 1 through 4. Among these scan profiles, the user IDs include X and Y, and the transfer IDs include ID1, ID2, ID3, and ID4.

TABLE 1

| No. | User ID | Transfer Id | Color Mode | Resolution Mode |
|---|---|---|---|---|
| 1 | X | ID1 | Color | High |
| 2 | Y | ID2 | Monochrome | Low |
| 3 | X | ID3 | Color | High |
| 4 | Y | ID4 | Monochrome | Low |

When the end user performs input operations to select a scan profile and to initiate reading, the controller 140 controls the scanning member 110 to read the document according to the modes (including the color mode and the resolution mode) specified in the scan profile. The controller 140 then transmits the image data generated by the scanning member 110 as a result of this reading to the homework transfer server 200 together with the user ID and transfer ID included in the scan profile.

The homework transfer server 200 is a computer (an example of the “first computer”) having hardware such as a CPU, memory including ROM and RAM, storage, and electronic circuits for performing a data communication process with external devices; and software stored in the memory, storage, or other storage device. Through the cooperation of this hardware and software, the homework transfer server 200 executes a homework delivery process and an answer submission process.

In the homework delivery process, the homework transfer server 200 transmits homework data contained in a homework delivery instruction received from the homework management server 300A or 300B to the printer 100, as will be described later. The homework delivery instruction includes a user ID. The homework transfer server 200 stores a delivery table that associates user IDs with destination printers 100. The homework transfer server 200 uses this table to transmit image data to the printer 100 associated with the user ID specified in the homework delivery instruction.

In the answer submission process, the homework transfer server 200 transmits the image data and user ID received from the printer 100 as a result of the answer reading operation described above to the homework management server 300A or 300B. The homework transfer server 200 also receives a transfer ID from the printer 100. The homework transfer server 200 saves a submission table. Table 2 described later is an example of a submission table. The submission table associates transfer IDs with user IDs and destination servers. In this example, the destination server is one of the homework management servers 300A and 300B. The homework transfer server 200 references this table to transmit the image data and user ID to the server associated with the transfer ID received from the printer 100, i.e., one of the homework management servers 300A and 300B.

Each of the homework management servers 300A and 300B is a computer (an example of the “second computer”) having hardware such as a CPU, memory including ROM and RAM, storage, and electronic circuits that perform a data communication process with external devices; and software stored in the memory, storage, or other storage device. Through the cooperation of this hardware and software, each of the homework management servers 300A and 300B executes a process to transmit a corresponding homework delivery instruction to the homework transfer server 200. The homework delivery instruction includes homework data, which is image data representing the content of the homework, and a user ID. Further, through the cooperation of this hardware and software, each of the homework management servers 300A and 300B executes a process to receive a user ID and image data from the homework transfer server 200. When one of the homework management servers 300A and 300B receives image data and a user ID from the homework transfer server 200, the operator of the corresponding server checks the homework for the user indicated by the user ID by evaluating answers (answers to the homework) shown in the image data.

According to the homework submission system 1 described above, both education providers A and B deliver homework to end users, and the end users submit their answers to this homework to the education providers A and B. At this time, provider X supports the delivery and submission of homework using the homework transfer server 200. In the present embodiment, a fee is charged for use of the service provided by provider X. The amount of this fee must be reasonable for both the end user and the provider.

Therefore, the homework submission system 1 according to the present embodiment is configured as follows. First, the homework transfer server 200 saves the submission table shown in the example of Table 2. The submission table includes as values transfer IDs, user IDs, and servers that are destination servers for associating transfer IDs with users and destination servers. In this table, “Server A” listed among the destination servers represents the homework management server 300A, and “Server B” represents the homework management server 300B. The submission table also includes a transfer limit, a transfer total, and a unit price for each transfer ID. The transfer limit (an example of the “predetermined upper limit”) indicates the upper limit on the amount (or, volume, size) of image data representing answers that can be transferred to the homework management server 300A or 300B per service period. The service period is a fixed length of time (e.g., one month) specified in an agreement associated with each transfer ID. The transfer total indicates the total amount of image data already transferred to the homework management server 300A or 300B during the current service period for a given transfer ID. In other words, the transfer total is information related to a transfer record or a transfer history. Each time image data is transferred to one of the homework management servers 300A and 300B, the corresponding transfer total is updated by adding the amount of image data transferred to the current value. The unit price is the amount charged per unit quantity of data.

TABLE 2

| Transfer | User | | Transfer | Transfer | |
|---|---|---|---|---|---|
| ID | ID | Server | Limit | Total | Unit Price |
| ID1 | X | Server A | 1 GB | 100 MB | “a” Yen/MB |
| ID2 | Y | Server A | 1 GB | 200 MB | “b” Yen/MB |
| ID3 | X | Server B | 500 MB | 300 MB | “c” Yen/MB |
| ID4 | Y | Server B | 500 MB | 300 MB | “d” Yen/MB |

In the answer submission process, the homework transfer server 200 checks the quantity of image data received from the printer 100 against information in the submission table associated with the transfer ID received from the printer 100. Specifically, the homework transfer server 200 determines whether the sum of the transfer total associated with the transfer ID and the quantity of image data received from the printer 100 exceeds the transfer limit associated with the transfer ID. When the homework transfer server 200 determines that this sum does not exceed the transfer limit, the homework transfer server 200 transmits the image data received from the printer 100 to the destination server associated with the transfer ID in the submission table. However, when the homework transfer server 200 determines that the sum exceeds the transfer limit, the homework transfer server 200 does not transmit the image data received from the printer 100 to the homework management server 300A or 300B and notifies the printer 100 of the error.

The homework transfer server 200 also calculates a billing amount corresponding to the transfer total. The billing amount is calculated by multiplying the transfer total by the unit price. For example, when the transfer total is 300 MB and the unit price is c yen/MB, the billing amount is calculated to be 300*c yen.

Next, the process flow in the homework submission system 1 will be described with reference to FIG. 2. First, in S1 the homework management server 300A or 300B transmits a homework delivery instruction to the homework transfer server 200. The homework delivery instruction includes the user ID. In response to this instruction, in S2 the homework transfer server 200 transmits homework data to the printer 100 associated with the user ID specified in the homework delivery instruction.

Next, in S3 the printer 100 performs a homework printing operation based on the image data received from the homework transfer server 200. As a result, in S4 the end user obtains one or more papers on which the homework has been printed. In S5 the end user then writes answers to the homework by hand on the printed papers. In S6 the end user places the document (including one or more printed sheets) with the handwritten answers on the printer 100 and inputs operations via the touchscreen display 130 instructing the printer 100 to begin reading (scanning). As a result, the printer 100 performs the answer reading operation. Specifically, in S7 the scanning member 110 of the printer 100 reads the document with the handwritten answers and in S8 transmits image data (scan data) representing the reading results (a scanned image, a reading resultant image) to the homework transfer server 200.

In S9 the homework transfer server 200 determines whether the sum of the quantity of image data received from the printer 100 in S8 and the transfer total in the submission table shown in the example of Table 2 exceeds the transfer limit. When the homework transfer server 200 determines that the sum does not exceed the transfer limit, in S10 the homework transfer server 200 transmits the image data received from the printer 100 in S8 to the homework management server 300A or 300B. In S11 the homework transfer server 200 updates the transfer total in the submission table by adding the quantity of image data just transmitted to the homework management server 300A or 300B. In S12 the homework transfer server 200 calculates the billing amount by multiplying the transfer total in the submission table by the unit price. In S13 the homework transfer server 200 transmits information on the billing amount calculated in S12 to the printer 100. In S14 the printer 100 displays this billing amount on the touchscreen display 130 to inform the end user.

On the other hand, when the homework transfer server 200 determines in S9 that the sum exceeds the transfer limit, in S15 the homework transfer server 200 does not transmit the image data received from the printer 100 to the homework management server 300A or 300B and notifies the printer 100 of the error. In response, in S16 the printer 100 displays an error message on the touchscreen display 130 to notify the end user that an error has occurred.

S15 and S16 constitute a process performed when the sum of the quantity of image data to be printed and the transfer total exceeds the transfer limit (hereinafter called the “overlimit process.” The following processes (A) and (B) are alternative approaches to the overlimit process.

(A) A process for transmitting image data to the homework management server 300A or 300B and increasing the billing amount: In this case, the billing amount may be calculated using a higher unit price than the unit price in the submission table. For example, when the unit price in the submission table is c yen/MB, the billing amount may be calculated according to the following formula 1. Here, the excess amount of data is found by subtracting the transfer limit from the transfer total.

$$Billing amount = transfer limit * c + excess amount of data * ( c + Δ ) \qquad Formula 1$$

Here, Δ is a positive value, and thus (c+Δ) is the higher unit price than the unit price in the submission table.

(B) A process for transmitting image data to the homework management server 300A or 300B while reducing the data transfer speed to a speed slower than the speed used when the sum of the quantity of image data and the transfer total does not exceed the transfer limit: Decreasing the data transfer speed is equivalent to increasing the time required to transfer the image data. Thus, this process may be achieved by suppressing the data transmission speed per unit time between the homework transfer server 200 and the homework management server 300A or 300B or by delaying the start time for transmitting the data from the homework transfer server 200 to the homework management server 300A or 300B, for example.

According to the embodiment described above, the homework transfer server 200 determines the billing amount based on the content of image data representing the reading results transmitted to the homework management server 300A or 300B. Therefore, the homework transfer server 200 can easily set a reasonable fee best on the reading results sent to the homework management server 300A or 300B.

In the present embodiment, the overlimit process configured of S15 and S16 in FIG. 2 is executed when the sum of the quantity of image data currently transmitted from the printer 100 and the transfer total in the submission table exceeds the transfer limit. In other words, when the total quantity of documents transmitted to the homework management server 300A or 300B within the current service period would exceed the transfer limit if the current document were sent, the homework transfer server 200 does not transmit the image data to the homework management server 300A or 300B. Therefore, the homework transfer server 200 can avoid transferring data to the homework management server 300A or 300B when the amount of data would exceed the transfer limit. Additionally, in a case that one of the above processes (A) or (B) is performed as the overlimit process, a balance can be achieved between the billing amount (the fee charged) and the amount of data transmitted to the homework management server 300A or 300B, making it easier to charge a reasonable fee for the amount of data transmitted.

In this embodiment, the homework transfer server 200 calculates the billing amount by multiplying the transfer total by a unit price. However, the homework transfer server 200 may instead derive an evaluation value for use in calculating the billing amount. For example, the homework transfer server 200 may calculate the ratio of the transfer total to the transfer limit as an evaluation value and output this evaluation value to an external device such as the printer 100. In this case, the billing amount is obtained by multiplying a base amount (base price) corresponding to the transfer limit by this evaluation value. The homework transfer server 200 may also output the transfer total itself as the evaluation value. In this case, the billing amount is obtained by multiplying the unit price shown in the example of Table 2 by this evaluation value.

Additionally, the homework transfer server 200 may output a rank derived from the transfer total. For example, Rank 1 may correspond to a case in which the transfer total is less than α(>0), Rank 2 to a case in which the transfer total is greater than or equal to a and less than or equal to β(>α), and Rank 3 to a case in which the transfer total is greater than β. In this case, the homework transfer server 200 may obtain a fee set in advance for each of the ranks as the billing amount for the rank, on the basis of these correspondences between ranks and values of the transfer total.

The evaluation value is greater than 0 and set so that the evaluation value grows larger as the quantity of documents being read (or transferred) grows larger, and the billing amount is calculated by separately multiplying this value by a predetermined unit price or base amount for example. As another example, the evaluation value may be a natural number that becomes larger the larger the quantity of documents read (or transferred), and the billing amount may be obtained from a table or the like that associates natural numbers with billing amounts.

### Second Embodiment

Next, a homework submission system 2 according to a second embodiment of the present disclosure will be described. Because the basic structures in the second embodiment are identical to those in the first embodiment, only the differences will be described below. Note that components identical to those in the first embodiment are designated with the same step numbers and reference numerals for referencing prior descriptions.

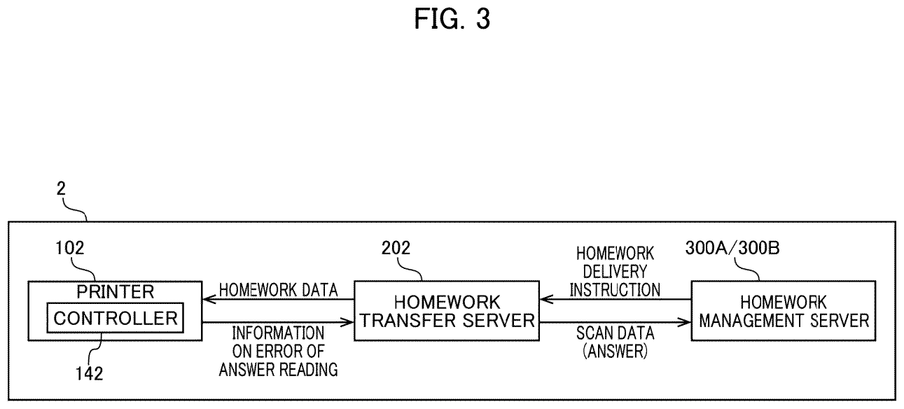

The homework submission system 2 according to the second embodiment differs from the homework submission system 1 of the first embodiment in that a printer 102 and a homework transfer server 202 are employed in place of the printer 100 and homework transfer server 200, as illustrated in FIG. 3. The printer 102 and homework transfer server 202 differ from the printer 100 and homework transfer server 200 in the first embodiment as will be detailed in the following description but are the same as the printer 100 and homework transfer server 200 in all other points.

The printer 102 includes a controller 142 in place of the controller 140. The printer 102 further includes the scanning member 110, the image forming member 120, and the touchscreen display 130 shown in FIG. 1. The controller 142 may has the scan profile table shown in FIG. 1. The controller has, in addition to the functions of the controller 140 described in the first embodiment, a function for detecting errors that occur during the answer reading operation. Specifically, the controller 142 determines whether a document reading error occurred when the scanning member 110 performed the answer reading operation. For example, the printer 102 may further includes: a conveying mechanism for conveying sheets of an original over the reading surface of the scanning member 110; and sensors for detecting whether sheets become jammed when conveyed by the conveying mechanism. In this case, the controller 142 determines whether an error has occurred based on detection results from the sensors. The controller 142 transmits results (results-information) of the above error determination to the homework transfer server 202 together with (or included) in image data representing the reading results.

For calculating a billing amount, the homework transfer server 202 subtracts a fixed amount from the value found by multiplying the transfer total in the submission table by the unit price in a case that the image data sent from the printer 102 corresponds to one of the following two cases. In the first case, the image data indicates or represents a presence of a blank page. Alternatively, the first case may be a case that the image data (or additional data generated in the reading of the document in S7) indicates that the read document includes a blank page. Or, the first case may be a case that one or more pages represented (or defined) in the image data have a blank page. In the second case, results of the error determination transmitted from the printer 102 indicate that an error occurred during the answer reading operation, and the image data indicates a presence of a blank area.

In these cases, there is a high probability that charging for all pages in the reading results would be inappropriate. In the first case, it would be natural for the last page in the reading results to be blank when both sides of the document sheets are read in the answer reading operation. In the second case, image data could be missing as a result of the error that occurred during the answer reading operation.

Therefore, in the first case the homework transfer server 202 subtracts a charge found by multiplying the quantity of data equivalent for one page by the unit price from the billing amount to account for the lack of data on the blank page. In the second case, the homework transfer server 202 subtracts a charge found by multiplying the quantity of data corresponding to the blank area by the unit price from the billing amount. This method facilitates the homework transfer server 202 in calculating a reasonable billing amount.

### Third Embodiment

A homework submission system 3 according to a second embodiment of the present disclosure will be described. Because the basic structures in the third embodiment are identical to those in the first embodiment, only the differences will be described below. Note that steps and components identical to those in the first embodiment are designated with the same step numbers and reference numerals for referencing prior descriptions.

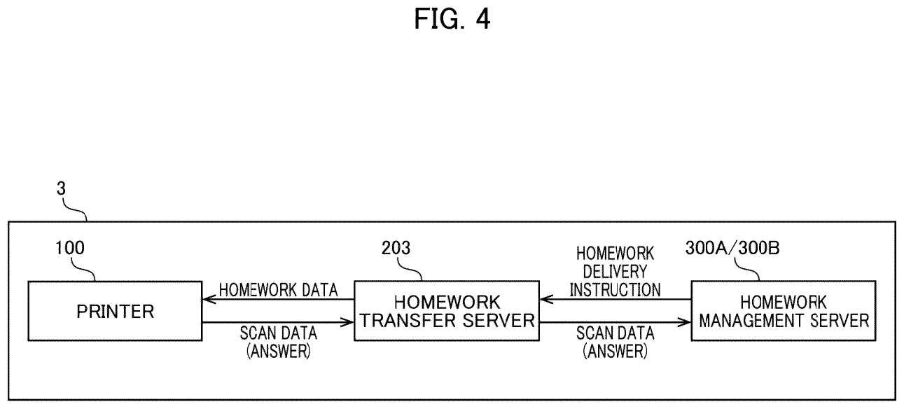

In the third embodiment, a flat rate (an example of the “flat fee” and “first fee”) is set for the use of services provided by provider X for a predetermined service period. This point differs from the first embodiment, which employs a usage-based billing system, as described above. For this reason, the homework submission system 3 according to the third embodiment employs a homework transfer server 203 shown in FIG. 4 in place of the homework transfer server 200 in the first embodiment. The homework transfer server 203 differs from the homework transfer server 200 according to the first embodiment as will be detailed in the following description but is the same as the homework transfer server 200 in all other points.

In place of the submission table shown in the example of Table 2, the homework transfer server 203 stores a submission table shown in the example of Table 3. Table 3 includes a flat rate for each service period, and an excess unit price in place of the unit price in Table 2. As will be described below, the excess unit price is used as a basis to calculate an extended billing amount that is a sum of flat rate for the service period and a surcharge in cases that the transfer total exceeds the transfer limit. The excess unit price is set to a value greater than the value of the flat rate divided by the transfer limit.

TABLE 3

| Transfer | User | | Transfer | | Transfer | Flat | Excess |
|---|---|---|---|---|---|---|---|
| ID | ID | Server | Limit | | Total | Rate | Unit Price |
| ID1 | X | Server A | 1 | GB | 100 MB | “g” | “k” |
| | | | | | | Yen | Yen/MB |
| ID2 | Y | Server A | 1 | GB | 200 MB | “h” | “m” |
| | | | | | | Yen | Yen/MB |
| ID3 | X | Server B | 500 | MB | 300 MB | “i” | “n” |
| | | | | | | Yen | Yen/MB |
| ID4 | Y | Server B | 500 | MB | 300 MB | “j” | “o” |
| | | | | | | Yen | Yen/MB |

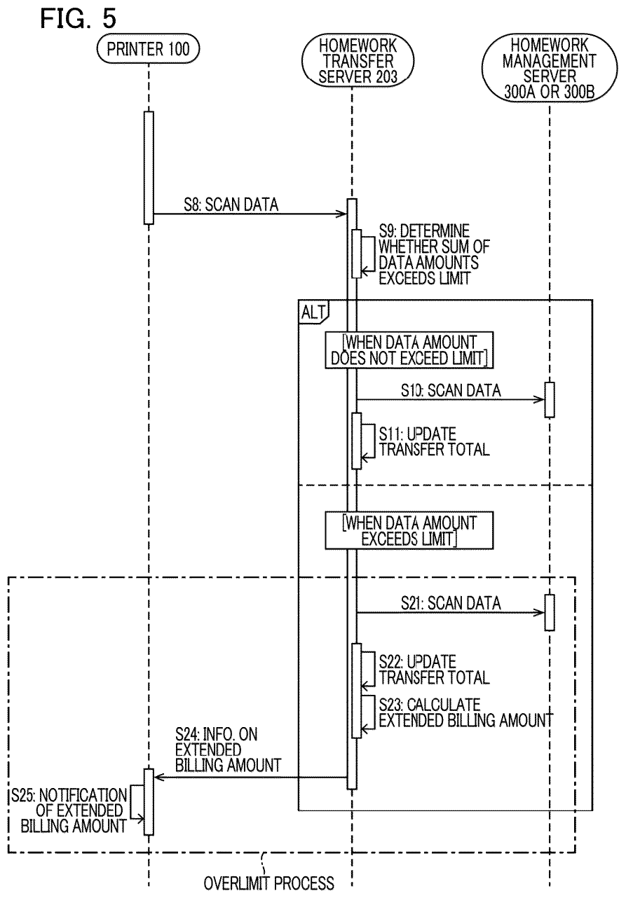

The process described in S1-S9 of FIG. 2 is also performed on the homework submission system 3. As shown in FIG. 5, when the homework transfer server 203 determines in S9 that the sum of the quantity of image data received from the printer 100 in S8 and the transfer total in the submission table does not exceed the transfer limit in the submission table, the homework transfer server 203 transmits the image data to the homework management server 300A or 300B in S10 and updates the transfer total in S11 but does not perform the process in S12-S14 of FIG. 2.

On the other hand, when the homework transfer server 203 determines in S9 that the sum exceeds the transfer limit, the homework transfer server 203 performs an overlimit process. In this process, the homework transfer server 203 transmits the image data to the homework management server 300A or 300B while switching from flat-rate billing to usage-based billing and sets the unit price for usage-based billing to a relatively high rate.

The specific steps in this overlimit process are shown in S21-S25 of FIG. 5. In S21 the homework transfer server 203 first transmits the image data received from the printer 100 in S8 to the homework management server 300A or 300B. In S22 the homework transfer server 203 updates the transfer total in the submission table by adding the quantity of image data transmitted in S21.

Next, in S23 the homework transfer server 203 calculates the extended billing amount by adding a surcharge at the excess unit price for the amount of data exceeding the transfer limit to the flat-rate billing charge for the service period. Here, a usage-based charge for the excess data transferred is found by multiplying the excess unit price by the excess quantity of data, and the extended billing amount is found by adding this usage-based charge to the flat-rate billing charge for the service period. The excess data quantity is calculated by subtracting the transfer limit from the transfer total. For example, when the transfer ID is ID1 in the above Table 3, the extended billing amount is calculated according to the following formula 2. In S24 the homework transfer server 203 transmits information on the extended billing amount calculated in S23 to the printer 100. In S25 the printer 100 displays this extended billing amount on the touchscreen display 130 to inform the end user.

$$extended billing amount = g + k * excess data quantity \qquad Formula 2$$

According to the present embodiment, the homework transfer server 203 charges a flat rate when the sum of the quantity of image data received from the printer 100 and the transfer total in the submission table does not exceed the transfer limit. However, when this sum exceeds the transfer limit, the homework transfer server 203 adds a usage-based charge to the flat rate. In other words, the homework transfer server 203 charges a larger amount than the flat rate fee according to the amount by which the transfer total exceeds the transfer limit for the current service period. Accordingly, the homework transfer server 203 can easily charge a reasonable fee for the transfer total, regardless of whether the transfer total exceeds the transfer limit or not.

As in the first embodiment, the overlimit process in this embodiment may be implemented through the process of S15 and S16 in FIG. 2 or process (B). When performing these processes, it is preferable to employ a flat-rate fee, as shown in the example of Table 3 in order to achieve a balance between the transfer total and the billing amount. Accordingly, the homework transfer server 203 can easily bill a reasonable amount in accordance with the transfer total.

### Variations of the Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, in the above embodiments the billing amount is calculated based on the quantity (or, size, amount) of image data representing the reading results for homework papers containing answers. However, the billing amount may be calculated based on the number of document sheets or a quantity of the document (an example of the “document number”, “the number related to the document”, the number of documents “, “the number of pages of the document” or “the number of sheets of the document”), or the size of the document (e.g., A4 or B5). Here, the quantity of the document may be the number of pages of the original document read by the scanning member 110, the number of sheets of the original document read by the scanning member 110, or the number of surfaces of the sheets of the document read by the scanning member 110. Or, the quantity of document may be the number of pages represented (or defined) by the scan data. The size of the document may be the size of the original document read by the scanning member 110. Or, the size of the document may be the size of pages of the document read in S7 or the size of document pages represented (or defined) by the scan data. In other words, the billing amount may be based on information (or attribute) of the image data (or the original document). Alternatively, a combination of two or more of the number of document sheets (or the quantity of the document), the size of the document, and the quantity of image data may be used as the basis for calculating the billing amount. When using a combination of the document size and number of sheets as the calculating basis, for example, the billing amount may be calculated based on the number of sheets at a rate of XX yen per A4-size sheet and a rate of YY yen per B5-size sheet. The image data transferred by the homework transfer server 200, 203, or 204 may include information on the number of document sheets (or the quantity of the document) and information on the size of the document.

The image data transferred by the homework transfer server 200, 202, 203, or 204 may be the image data representing all the document with the handwritten answers read in S7. Alternatively, the image data transferred by the homework transfer server 200, 203, or 204 may be the image data representing parts of the document with the handwritten answers read in S7. For example, the image data may represent one or more sheets having the handwritten answers. Further alternatively, the homework transfer server 200, 203, or 204 may transfer data extracted and/or converted from the image data representing all the document with the handwritten answers.

In the above embodiments, a billing amount is calculated by the homework transfer server 200 or the like each time image data is transferred to the homework management server 300A or 300B. However, the billing amount may be calculated at a timing different from when image data is transferred, such as on the final day of the predetermined service period.

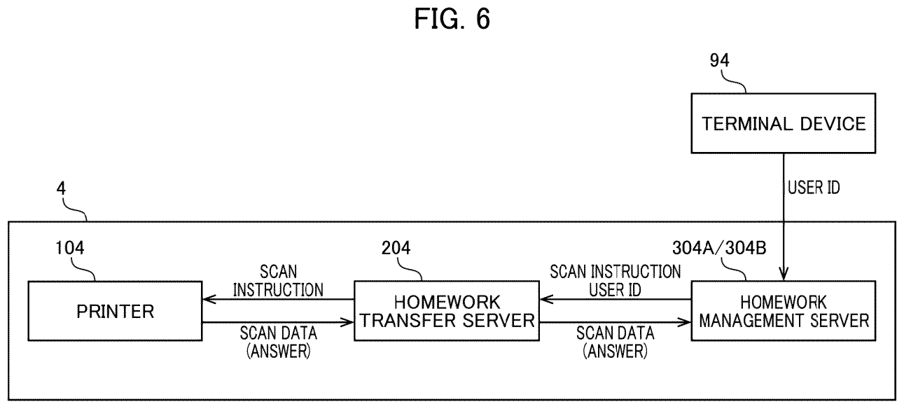

In the above embodiments, the printer 100 begins an answer reading operation in response to an instruction inputted by the user through the touchscreen display 130. However, an instruction to begin the answer reading operation may be issued in another manner. As shown in the example of FIG. 6, a homework submission system 4 includes a printer 104, a homework transfer server 204, and homework management servers 304A and 304B. In this configuration, the end user of the printer 104 may use a terminal device 94 to access the homework management server 304A or 304B. In response to this access, the homework management server 304A or 304B may transmit a scan instruction (an instruction to start scanning answers) to the homework transfer server 204. In this case, the terminal device 94 transmits the user ID of the end user to the homework management server 304A or 304B, and the homework management server 304A or 304B transmits the user ID to the homework transfer server 204 together with the scan instruction. In response to this scan instruction, the homework transfer server 204 transmits a scan instruction to the printer 104 associated with the user ID, and the printer 104 performs an answer reading operation. The printer 104 generates image data (scan data) representing answers as the reading results of the answer reading operation and transmits this image data to the homework management server 304A or 304B via the homework transfer server 204. The image data transmitted in S8 and/or S10 may be all the image data read in S7 or may be part of the image data that represents areas or pages including answers to the homework.

As an alternative configuration, a single server possessing the functions of both the homework transfer server 200 and the homework management server 300A or 300B may be employed. In this case, this server transmits image data of homework to the printer 100, and the printer 100 transmits image data (scan data), representing answers to the homework as the reading results, to the server. The server calculates the billing amount based on the amount of image data received from the printer 100.

The system in the above embodiments uses a printer 100 or the like that possesses both a function for forming images and a function for reading documents. However, a reading device provided with a function for reading documents but not a function for forming images may be used in place of the printer 100 or the like. In this case, a printer or the like separate from the reading device may be used to print the homework.

The above embodiments assume that there are two education providers A and B, but the present invention may be applied to systems involving one or three or more education providers. Moreover, the homework management servers 300A and 300B (or, 304A and 304B) are one component of the homework submission system 1. That is, each embodiment describes two servers 300A and 300B (examples of the second computers of the present disclosure) as components in the system. However, the two servers 300A and 300B (or, 304A and 304B) (examples of the second computer of the present disclosure) may be both considered components outside the system. That is, the information processing system of the present disclosure may be associated with a system having the printer 100 and homework transfer server 200, while the homework management servers 300A and 300B constitute external components.

Additionally, each of the above embodiments and variations describes cases in which the present invention is applied to each of the homework submission systems 1-4, but the present invention is not limited to these configurations. The present invention may be applied to other inkjet-based image forming devices that eject ink from a head, such as multifunction peripherals or copiers. The present invention may also be applied to systems having laser-based image forming devices that perform image recording processes by depositing toner on printing paper instead of by depositing ink on printing paper, as described in the inkjet method. In this case, toner cartridges accommodating toner are removably mounted in the image forming device.

What is claimed is:

1. A data processing system comprising:
a reading device; and
a first computer configured to communicate with the reading device and a second computer,
wherein the reading device is configured to perform:
a reading process to read an original document to generate a set of resultant data based on the read original document; and
a transmission process to transmit the set of resultant data to the first computer,
wherein the first computer is configured to perform:
a transferring process to transfer the set of resultant data received from the reading device to the second computer; and
an acquisition process to acquire a billing amount or an evaluation value, the billing amount and the evaluation value both being based on information concerning the set of resultant data, the billing amount being an amount of a fee to be charged, the evaluation value being a value for use in calculating the billing amount.

2. The data processing system according to claim 1, wherein the information concerning the set of resultant data is the number of pages of the original document, the number of sheets of the original document, a size of data representing content of the original document, a sheet size of the original document, the number of pages represented in the set of resultant data, or a page size of one or more pages represented in the set of resultant data.

3. The data processing system according to claim 1, wherein the billing amount is smaller when the set of resultant data indicates that the original document has a blank page than when the set of resultant data indicates that the original document has no blank page.

4. The data processing system according to claim 1, wherein the billing amount is smaller when one or more pages represented by the set of resultant data has a blank page than when the one or more pages represented by the set of resultant data has no blank page.

5. The data processing system according to claim 1, wherein the billing amount is smaller when the set of resultant data includes blank-area data than when the set of resultant data does not include the blank-area data, the blank-area data representing a blank area caused by an error occurred in the reading device.

6. The data processing system according to claim 1, wherein the first computer is configured to perform, when a prescribed condition is not satisfied, at least one of:
a first process to perform the transferring process to transfer the set of resultant data at a transfer speed lower than a transfer speed when the prescribed condition is satisfied;
a second process to set the billing amount larger than a specific billing amount, the specific billing amount being a billing amount when the prescribed condition is satisfied; or
a third process to skip the transferring process,
wherein the prescribed condition includes a condition that a total data size of one or more sets of resultant data having been transferred to the second computer within a prescribed time period is less than a prescribed upper limit.

7. The data processing system according to claim 1,
wherein the reading device includes:
a printing engine configured to form an image on a sheet; and
a controller configured to control the printing engine to print a document image on a sheet based on a set of document data,
wherein the original document is based on the sheet on which the document image has been printed.

8. A data processing system comprising:
a reading device; and
a first computer configured to communicate with the reading device and a second computer,
wherein the reading device is configured to perform:
a reading process to read an original document to generate a set of resultant data based on the read original document; and
a transmission process to transmit the set of resultant data to the first computer,
wherein the first computer is configured to perform:
providing a flat-fee service while a prescribed condition is satisfied, the flat-fee service being a service to transfer each set of resultant data received from the reading device to the second computer for a prescribed time period at a flat fee, the prescribed condition including a condition that a transferred-data size of one or more sets of resultant data that have been transferred from the first computer to the second computer for the prescribed time period is less than an upper limit; and
after the prescribed condition is not satisfied, at least one of:
a first process to transfer the set of resultant data received from the reading device to the second computer at a transfer speed lower than a transfer speed when the prescribed condition is satisfied;
a second process to transfer the set of resultant data to the second computer while charging an additional fee; or
a third process to skip transferring of the set of resultant data from the first computer to the second computer.

9. The data processing system according to claim 8,
wherein the reading device includes:
a printing member configured to form an image on a sheet; and
a controller configured to control the printing member to print a document image on a sheet based on a set of document data,
wherein the document read in the reading process is based on the sheet on which the document image is printed.

10. The data processing system according to claim 8, wherein the additional fee is based on a total data size exceeding the upper limit, the total data size is a sum of a size of the set of resultant data and the transferred-data size of the one or more sets of resultant data that have been transferred from the first computer to the second computer.
